(19) United States
(12) Patent Application Publication
(10) Pub. No.: US 2026/0239403 A1
(43) Pub. Date: Aug. 13, 2026

(54) METHOD AND APPARATUS FOR AVOIDING IN-DEVICE COEXISTENCE INTERFERENCE

(71) Applicant: LENOVO (BEIJING) LIMITED, Beijing (CN)

(72) Inventors: Lianhai Wu, Beijing (CN); Jing Han, Beijing (CN); Haipeng Lei, Beijing (CN); Ran Yue, Beijing (CN); Min Xu, Beijing (CN)

(21) Appl. No.: 19/152,978

(22) PCT Filed: Feb. 3, 2023
(86) PCT No.: PCT/CN2023/074403

§ 371 Date: Aug. 1, 2025

(51) Int. Cl. H04W 72/541; H04W 72/0453; H04W 72/0457; H04W 76/15

(52) U.S. Cl. CPC H04W 72/541; H04W 72/0453; H04W 72/0457; H04W 76/15

(57) ABSTRACT

Embodiments of the present disclosure relate to IDC interference avoidance in a communication system. According to some embodiments of the disclosure, a UE may: receive an IDC configuration from a BS, wherein the IDC configuration is associated with a first frequency to be detected by the UE, and the first frequency includes at least one serving frequency, at least one non-serving frequency, or both; detect IDC interference based on the configuration; and transmit an IDC report to the BS in response to detecting the IDC interference.

### TECHNICAL FIELD

Embodiments of the present disclosure generally relate to communication technology, and more particularly to in-device coexistence (IDC) interference avoidance in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may support multiple radio access technologies (RATs) including 3GPP RATs such as LTE or NR, and non-3GPP RATs such as industrial, science and medical (ISM) technologies (such as Bluetooth or WLAN), and global navigation satellite system (GNSS) technologies (e.g., gps, glonass, bds, galileo or navIC). Co-existence interference may arise between a 3GPP RAT and a non-3GPP RAT(s) (e.g., GNSS, WiFi, Bluetooth, etc.).

Mechanisms for avoiding in-device coexistence (IDC) interference are desired.

### SUMMARY

Some embodiments of the present disclosure provide a UE. The UE may include: a transceiver; and a processor coupled to the transceiver. The processor may be configured to: receive an in-device coexistence (IDC) configuration from a BS, wherein the IDC configuration is associated with a first frequency to be detected by the UE, and the first frequency includes at least one serving frequency, at least one non-serving frequency, or both; detect IDC interference based on the configuration; and transmit an IDC report to the BS in response to detecting the IDC interference.

Some embodiments of the present disclosure provide a first BS. The first BS may include: a transceiver; and a processor coupled to the transceiver. The processor may be configured to: transmit, to a UE, an in-device coexistence (IDC) configuration, wherein the IDC configuration includes a first IDC configuration associated with a master cell group (MCG) configured for the UE by the first BS, a second IDC configuration associated with a secondary cell group (SCG) configured for the UE by a second BS, or both; and receive an IDC report from the UE, wherein the IDC report is based on the IDC configuration and indicates IDC interference at the UE.

In some embodiments of the present disclosure, the processor may be further configured to receive the second IDC configuration from the second BS via an Xn interface.

In some embodiments of the present disclosure, the IDC report includes at least one of the following: a list of frequencies affected by the IDC interference; a bandwidth(s) corresponding to the list of frequencies; a cell group (CG) ID associated with the IDC interference; or a victim type of the IDC interference.

In some embodiments of the present disclosure, the processor may be further configured to perform at least one of the following: transmitting a first message to the second BS in response to the first BS being unable to solve an IDC problem in the IDC report; informing the second BS that an IDC problem in the IDC report is solved by the first BS; receiving, from the second BS, an indication that an IDC problem in the IDC report is solved by the second BS; or receiving, from the second BS, a second message indicating that the second BS is unable to solve an IDC problem in the IDC report.

In some embodiments of the present disclosure, the first message or the second message includes at least one of the following: a list of frequencies affected by the IDC problem; a bandwidth(s) corresponding to the list of frequencies; a cell group (CG) ID associated with the IDC problem; a victim type of the IDC problem; a suggestion for solving the IDC problem; or a cause of the IDC problem.

In some embodiments of the present disclosure, the processor may be further configured to perform at least one of the following: receiving a first response to the first message, wherein the first response indicates whether the IDC problem is solved or not; or transmitting a second response to the second message, wherein second response indicates whether the IDC problem is solved or not.

In some embodiments of the present disclosure, the IDC report indicates a second frequency affected by the IDC interference. In some embodiments, the second frequency is represented by the frequency offset and one of the at least one radio frequency channel number. In some embodiments, the second frequency is represented by the frequency offset, a weighting value of the frequency offset, and one of the at least one radio frequency channel number. In some embodiments, the second frequency is represented by indexes of radio frequency channel numbers associated with the second frequency among the at least one radio frequency channel number.

In some embodiments of the present disclosure, the IDC report indicates a second frequency affected by the IDC interference, and a bandwidth of the second frequency is based on the minimum bandwidth or both the minimum bandwidth and the incremental bandwidth.

In some embodiments of the present disclosure, the IDC report includes a weighting value of the minimum bandwidth or a weighting value of the incremental bandwidth.

In some embodiments of the present disclosure, the processor may be further configured to transmit at least one of the following to the UE: a first indication enabling master node (MN) inter-modulation distortion (IMD) detection; a second indication enabling secondary node (SN) IMD detection; a third indication enabling IMD detection between an MN and an SN; or a fourth indication enabling sidelink IMD detection.

In some embodiments of the present disclosure, the first indication configures the UE to report IMD related information for the first BS. In some embodiments of the present disclosure, the second indication configures the UE to report IMD related information for the second BS. In some embodiments of the present disclosure, the third indication configures the UE to report IMD related information between the first BS and the second BS. In some embodiments of the present disclosure, the fourth indication configures the UE to report IMD related information for a sidelink of the UE.

In some embodiments of the present disclosure, the IDC report includes direction information of the IDC interference.

In some embodiments of the present disclosure, the direction information of the IDC interference indicates at least one of the following: a victim of the IDC interference is the MCG; a victim of the IDC interference is the SCG; a victim of the IDC interference is a radio system based on a non-3GPP radio access technology (RAT); a victim of the IDC interference is a sidelink of the UE; a victim of the IDC interference includes the MCG and SCG; a victim of the IDC interference includes the MCG and the sidelink of the UE; a victim of the IDC interference includes the MCG and the radio system based on a non-3GPP RAT; a victim of the IDC interference includes the SCG and the sidelink of the UE; a victim of the IDC interference includes the SCG and the radio system based on a non-3GPP RAT; a victim of the IDC interference includes the MCG and SCG and the sidelink of the UE; or a victim of the IDC interference includes the MCG and SCG and the radio system based on a non-3GPP RAT.

In some embodiments of the present disclosure, the processor may be further configured to receive IDC related capability from the UE. The IDC related capability may indicate at least one of the following: whether the UE supports IDC assistance information for DC; whether the UE supports IDC assistance information for a SCG configured for the UE; or whether the UE supports IDC assistance information for IMD detection in DC.

Some embodiments of the present disclosure provide a second BS. The second BS may include: a transceiver; and a processor coupled to the transceiver. The processor may be configured to: transmit, to a first BS or a UE, an in-device coexistence (IDC) configuration, wherein the UE is configured with a master cell group (MCG) associated with the first BS and a secondary cell group (SCG) associated with the second BS, and the IDC configuration is associated with the SCG; and receive an IDC report from the first BS or the UE, wherein the IDC report is based on the IDC configuration and indicates IDC interference at the UE.

In some embodiments of the present disclosure, the processor may be further configured to perform at least one of the following: transmitting the IDC configuration to the UE via SRB3 or split SRB1 between the UE and the second BS; transmitting the IDC configuration to the first BS via an Xn interface; receiving the IDC report from the UE via the SRB3 or the split SRB1; or receiving the IDC report from the first BS via the Xn interface.

In some embodiments of the present disclosure, the IDC configuration indicates at least one of: at least one radio frequency channel number for a first frequency to be detected by the UE; a bandwidth of the first frequency; or a frequency offset relative to the at least one radio frequency channel number.

In some embodiments of the present disclosure, the IDC report indicates a second frequency affected by the IDC interference, and the second frequency is represented by: the frequency offset and one of the at least one radio frequency channel number; the frequency offset, a weighting value of the frequency offset, and one of the at least one radio frequency channel number; or indexes of radio frequency channel numbers associated with the second frequency among the at least one radio frequency channel number.

In some embodiments of the present disclosure, the IDC configuration indicates at least one of: a list of bandwidths for IDC reporting; a minimum bandwidth for IDC reporting; or the minimum bandwidth and an incremental bandwidth.

In some embodiments of the present disclosure, the IDC report indicates a second frequency affected by the IDC interference, and a bandwidth of the second frequency is based on: the list of bandwidths; the minimum bandwidth; or the minimum bandwidth and the incremental bandwidth.

In some embodiments of the present disclosure, the IDC report includes a weighting value of the minimum bandwidth or a weighting value of the incremental bandwidth.

In some embodiments of the present disclosure, the processor may be further configured to perform at least one of the following: receiving, from the first BS, a first message indicating that the first BS is unable to solve an IDC problem in the IDC report; receiving, from the first BS, an indication that an IDC problem in the IDC report is solved by the first BS; transmitting, to the first BS, an indication that an IDC problem in the IDC report is solved by the second BS; or transmitting, to the first BS, a second message indicating that the second BS is unable to solve an IDC problem in the IDC report.

In some embodiments of the present disclosure, at least one of the first message or the second message includes at least one of the following: a list of frequencies affected by the IDC problem; a bandwidth(s) corresponding to the list of frequencies; a CG ID associated with the IDC problem; a victim type of the IDC problem; a suggestion for solving the IDC problem; or a cause of the IDC problem.

In some embodiments of the present disclosure, the processor may be further configured to perform at least one of the following: transmitting a first response to the first message, wherein the first response indicates whether the IDC problem is solved or not; or receiving a second response to the second message, wherein the second response indicates whether the IDC problem is solved or not.

In some embodiments of the present disclosure, the processor may be further configured to transmit at least one of the following to the UE: a second indication enabling SN IMD detection; a third indication enabling IMD detection between a MN and an SN; or a fourth indication enabling sidelink IMD detection.

In some embodiments of the present disclosure, the second indication configures the UE to report IMD related information for the second BS. In some embodiments of the present disclosure, the third indication configures the UE to report IMD related information between the first BS and the second BS. In some embodiments of the present disclosure, the fourth indication configures the UE to report IMD related information for a sidelink of the UE.

In some embodiments of the present disclosure, the IDC report includes direction information of the IDC interference.

In some embodiments of the present disclosure, the direction information of the IDC interference indicates at least one of the following: a victim of the IDC interference is the MCG; a victim of the IDC interference is the SCG; a victim of the IDC interference is a radio system based on a non-3GPP RAT; a victim of the IDC interference is a sidelink of the UE; a victim of the IDC interference includes the MCG and SCG; a victim of the IDC interference includes the MCG and the sidelink of the UE; a victim of the IDC interference includes the MCG and the radio system based on a non-3GPP RAT; a victim of the IDC interference includes the SCG and the sidelink of the UE; a victim of the IDC interference includes the SCG and the radio system based on a non-3GPP RAT; a victim of the IDC interference includes the MCG and SCG and the sidelink of the UE; or a victim of the IDC interference includes the MCG and SCG and the radio system based on a non-3GPP RAT.

In some embodiments of the present disclosure, the processor may be further configured to receive IDC related capability from the UE. The IDC related capability may indicate at least one of the following: whether the UE supports IDC assistance information for DC; whether the UE supports IDC assistance information for a SCG configured for the UE; or whether the UE supports IDC assistance information for IMD detection in DC.

Some embodiments of the present disclosure provide a method performed by a UE. The method may include: receiving an in-device coexistence (IDC) configuration from a BS, wherein the IDC configuration is associated with a first frequency to be detected by the UE, and the first frequency includes at least one serving frequency, at least one non-serving frequency, or both; detecting IDC interference based on the configuration; and transmitting an IDC report to the BS in response to detecting the IDC interference.

Some embodiments of the present disclosure provide a method performed by a first BS. The method may include: transmitting, to a UE, an in-device coexistence (IDC) configuration, wherein the IDC configuration includes a first IDC configuration associated with a master cell group (MCG) configured for the UE by the first BS, a second IDC configuration associated with a secondary cell group (SCG) configured for the UE by a second BS, or both; and receiving an IDC report from the UE, wherein the IDC report is based on the IDC configuration and indicates IDC interference at the UE.

Some embodiments of the present disclosure provide a method performed by a second BS. The method may include: transmitting, to a first BS or a UE, an in-device coexistence (IDC) configuration, wherein the UE is configured with a master cell group (MCG) associated with the first BS and a secondary cell group (SCG) associated with the second BS, and the IDC configuration is associated with the SCG; and receiving an IDC report from the first BS or the UE, wherein the IDC report is based on the IDC configuration and indicates IDC interference at the UE.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2-4 illustrate flow charts of exemplary procedures for avoiding IDC interference in accordance with some embodiments of the present disclosure;

FIG. 5 illustrates a flow chart of an exemplary communication procedure performed by a UE in accordance with some embodiments of the present disclosure; and

FIGS. 6 and 7 illustrate flow charts of exemplary communication procedures performed by a BS in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

In some embodiments of the present disclosure, a wireless communication system may support a multi-radio dual connectivity (MR-DC) operation. In a MR-DC scenario, a UE may be configured with multiple transceivers and may be configured to utilize resources provided by two different nodes (e.g., two BSs) or different cells of the same BS. In some examples, one node may provide new radio (NR) access and the other one node may provide either evolved-universal mobile telecommunication system (UMTS) terrestrial radio access (UTRA) (E-UTRA) or NR access. In some examples, one node may act as a master node (MN) and the other node may act as a secondary node (SN). The MN and SN are connected via a network interface (for example, the Xn interface as specified in 3GPP specifications), and at least the MN may be connected to the core network. In some examples, a UE may be connected to a single BS, which acts as both the MN and SN.

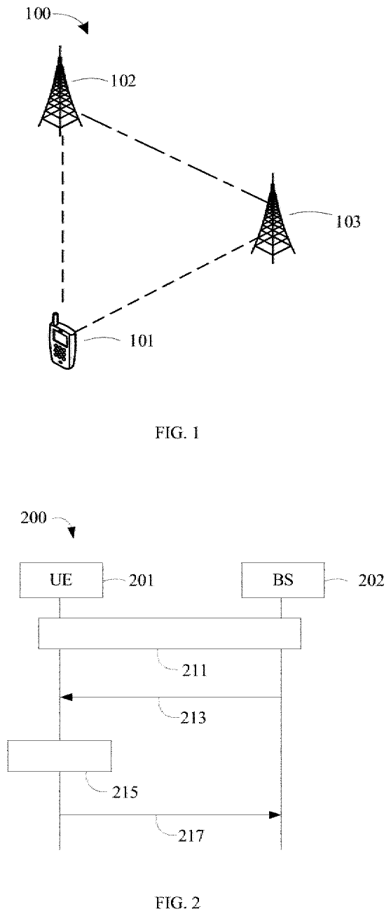

FIG. 1 illustrates a schematic diagram of wireless communication system 100 in accordance with some embodiments of the present disclosure. As shown in FIG. 1, wireless communication system 100 may be a dual connectivity system, and may include at least one UE (e.g., UE 101) and some base stations (e.g., BS 102 acting as a master node (MN), and BS 103 acting as an SN). Although a specific number of UEs and BSs are depicted in FIG. 1, it is contemplated that any number of UEs and BSs (e.g., MNs or SNs) may be included in wireless communication system 100. For example, UE 101 may be connected to a single BS, which acts as both the MN and SN.

Referring to FIG. 1, UE 101 may be connected to BS 102 and BS 103 via a network interface, for example, the Uu interface as specified in 3GPP standard documents. The link established between a UE (e.g., UE 101) and a BS (e.g., BS 102) may be referred to as a Uu link. BS 102 and BS 103 may be connected to each other via a network interface, for example, the Xn interface as specified in 3GPP standard documents. In some examples, BS 102 may be connected to the core network via a network interface (not shown in FIG. 1). UE 101 may be configured to utilize resources provided by BS 102 and BS 103 to perform transmissions. In some examples, UE 101 may be connected to another UE (not shown in FIG. 1) via a sidelink.

In some embodiments of the present disclosure, BS 102 may refer to a radio access node that provides a control plane connection to the core network. In some embodiments, in the E-UTRA-NR dual connectivity (EN-DC) scenario, BS 102 may be an eNB. In some embodiments, in the next generation (NG) radio access network (RAN) E-UTRA-NR dual connectivity (NGEN-DC) scenario, BS 102 may be an ng-eNB. In some embodiments, in the NR-E-UTRA dual connectivity (NE-DC) scenario or the NR-NR dual connectivity (NR-DC) scenario, BS 102 may be a gNB.

BS 102 (e.g., MN) may be associated with a master cell group (MCG). The MCG may refer to a group of serving cells associated with BS 102, and may include a primary cell (PCell) and optionally one or more secondary cells (SCells) of the MCG. The PCell may provide a control plane connection to UE 101.

In some embodiments of the present disclosure, BS 103 may refer to a radio access node without a control plane connection to the core network, but providing additional resources to UE 101. In some embodiments, in the EN-DC scenario, BS 103 may be an en-gNB. In some embodiments, in the NE-DC scenario, BS 103 may be an ng-eNB. In some embodiments, in the NR-DC scenario or the NGEN-DC scenario, BS 103 may be a gNB.

BS 103 (e.g., SN) may be associated with a secondary cell group (SCG). The SCG may refer to a group of serving cells associated with BS 103, and may include a primary secondary cell (PSCell) and optionally one or more secondary cells (SCells). For example, the SCG may be a subset of serving cells of BS 103. The PCell of the MCG and the PSCell of the SCG may also be referred to as a special cell (SpCell).

In some other embodiments, in the NE-DC scenario, UE 101 may be connected to a single BS, which acts as both the MN and SN and configures both the MCG and SCG for UE 101.

In some embodiments of the present disclosure, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some embodiments of the present disclosure, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some embodiments of the present disclosure, UE 101 may include wearable devices, such as smart watches, fitness bands, optical head-mounted displays, or the like. In some embodiments of the present disclosure, UE 101 may include, for example, but is not limited to, an internet of things (IOT) device or a vehicle. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. Persons skilled in the art should understand that as technology develops and advances, the terminologies described in the present disclosure may change, but should not affect or limit the principles and spirit of the present disclosure.

As stated above, a UE may support multiple RATs which may cause an IDC problem. In some embodiments of the present disclosure, the problem may come from a harmonic signal(s). In some embodiments of the present disclosure, the problem may come from an inter-modulation distortion (IMD) signal(s). For example, the harmonic signal may involve one uplink (UL) signal from an aggressor RAT. For example, the IMD signals may involve two UL signals from an aggressor RAT(s).

In some embodiments of the present disclosure, a UE may perform the following operations to avoid IDC interference. The UE may detect an internal issue or the possibility of an internal issue caused by coexistence related to usage of certain radio resources that the UE cannot resolve by itself. For example, the UE can provide information related to the resource affected by IDC interference. The UE may provide information related to the detected (potential) internal issue to a BS (e.g., its serving BS) to assist the BS to solve the issue. For example, the BS may restrict radio resource usage to avoid the UE's (potential) internal issue.

In the scenario of MR-DC, IDC problem may also exist. The above embodiments for avoiding IDC interference can be similarly applied. Embodiments of the present disclosure further provide enhanced solutions to solve the IDC problem in the scenario of MR-DC. For example, embodiments of the present disclosure may coordinate between an MN and an SN of a UE for avoiding IDC interference. For example, embodiments of the present disclosure design a mechanism to enable IMD detection. For instance, SN IMD detection can be implicitly or explicitly enabled. For example, embodiments of the present disclosure may enhance the IDC configuration for a UE and may enhance the IDC report. For instance, embodiments of the present disclosure provide solutions for configuring frequency and bandwidth information for IDC interference detection and IDC reporting. For instance, embodiments of the present disclosure provide solutions for indicating the direction of the IDC interference. Proposed solutions in the present disclosure can, for example, provide a more fine IDC report, thereby facilitating the avoidance of the IDC interference. More details on the embodiments of the present disclosure will be illustrated in the following text in combination with the appended drawings.

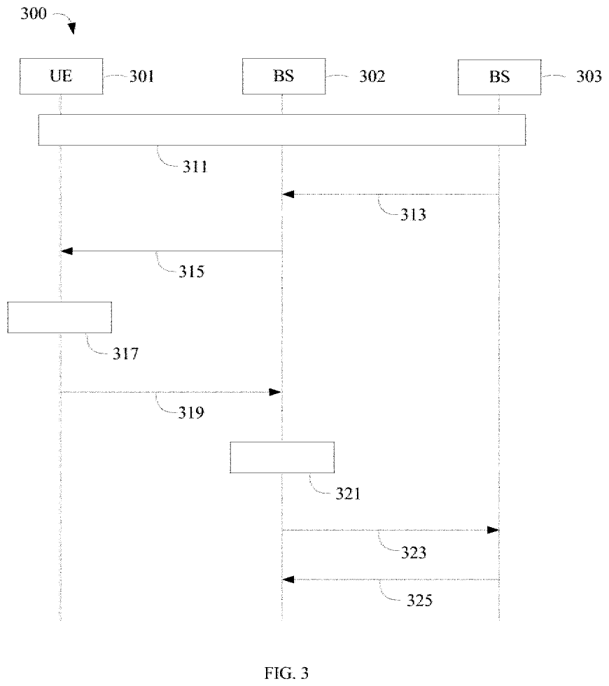

FIG. 2 illustrates a flow chart of exemplary procedure 200 for avoiding IDC interference in accordance with some embodiments of the present disclosure. Details described in all of the foregoing embodiments of the present disclosure are applicable for the embodiments shown in FIG. 2.

Referring to FIG. 2, in operation 211, UE 201 may be in a connected state (e.g., RRC_CONNECTED state as specified in 3GPP specifications) and may access its serving BS(s) (e.g., BS 202). BS 202 may be an MN or an SN.

In some embodiments, UE 201 may transmit IDC related capability to its serving BS(s) (e.g., BS 202). The IDC related capability may indicate at least one of the following: whether UE 201 supports IDC assistance information for dual connectivity (DC) (hereinafter referred to as “IDC for DC”); whether UE 201 supports IDC assistance information for SCG (hereinafter referred to as “IDC for SCG”); or whether UE 201 supports IDC assistance information for IMD in a DC scenario (hereinafter referred to as “IDC for IMD in DC”).

In operation 213, BS 202 (e.g., the MN or the SN) may transmit an IDC configuration to UE 201.

In some embodiments of the present disclosure, the IDC configuration may be associated with a frequency (denoted as frequency #1) to be detected by UE 201. For example, the IDC configuration may include the information of frequency #1.Frequency #1 may include at least one serving frequency, at least one non-serving frequency, or both. A serving frequency may refer to a frequency of a serving cell of UE 201. For the non-serving frequency, the IDC configuration may further include a corresponding bandwidth, which can be applied to the non-serving frequency for IDC interference detection and/or reporting.

In some embodiments of the present disclosure, the IDC configuration may indicate at least one of: at least one radio frequency channel number (e.g., at least one absolute radio frequency channel number (ARFCN) value) for frequency #1; or a frequency offset relative to the at least one radio frequency channel number. In some other embodiments of the present disclosure, the frequency offset may be indicated in the IDC configuration, but may be predefined (e.g., in a standard(s)) or preconfigured.

For example, in some embodiments, the IDC configuration may list a plurality of radio frequency channel numbers for a single frequency (e.g., a serving frequency or a non-serving frequency). For example, the IDC configuration may list a plurality of ARFCN values for each frequency to be detected.

For example, in some embodiments, the IDC configuration may include a single radio frequency channel number for a single frequency (e.g., a serving frequency or a non-serving frequency). The IDC configuration may include frequency information for one or more frequencies (e.g., serving frequencies or non-serving frequencies). For example, the IDC configuration may include a single ARFCN value for each frequency to be detected. In some embodiments, for each non-serving frequency, the IDC configuration may further include a corresponding bandwidth to be applied to the non-serving frequency. In some embodiments, the IDC configuration may further include a frequency offset that can be applied to the radio frequency channel number(s).

In some embodiments of the present disclosure, the IDC configuration may include the bandwidth information for IDC interference detection and/or reporting. For example, the IDC configuration may indicate at least one of: a list of bandwidths for IDC reporting, a minimum bandwidth (denoted as bandwidth #1) for IDC reporting, or the minimum bandwidth and an incremental bandwidth (denoted as bandwidth #2). The bandwidth(s) in the context of the present disclosure can be configured or indicated in the form of a resource block (RB) number, a physical RB (PRB) number, or a resource block group (RBG) number.

In operation 215, UE 201 may detect IDC interference based on the received IDC configuration. For example, UE 201 may detect IDC interference on the frequencies (e.g., frequency #1) to be detected as indicated in the IDC configuration.

In some embodiments, UE 201 may detect the IDC interference (e.g., an IDC problem). In operation 217, UE 201 may transmit an IDC report to BS 202 (e.g., the MN or the SN) in response to detecting the IDC interference. For example, UE 201 may report IDC related information when an IDC problem is detected and cannot be solved by UE 201. The IDC report may indicate a frequency (denoted as frequency #2) affected by the IDC interference. Frequency #2 may include at least one serving frequency, at least one non-serving frequency, or both.

It should be noted that in the present disclosure, the BS which configures the IDC configuration and receives the IDC report may not necessarily be the same BS. For example, in some examples, both the SN of a UE may transmit an IDC configuration to the UE, which may only transmit an IDC report to the MN of the UE.

In the context of the present disclosure, an IDC problem (or IDC interference) at a UE may include, but not limited to, at least one of the following: two (or more) UL signals associated with the IMD are from the MCG of the UE; two (or more) UL signals associated with the IMD are from the SCG of the UE; two (or more) UL signals associated with the IMD are from the MCG and SCG; two (or more) UL signals associated with IMD are from the sidelink of the UE (e.g., the UE supports the carrier aggregation (CA) based sidelink); two (or more) UL signals associated with the IMD are from a radio under a non-3GPP RAT radio (hereinafter, “other radio”) and/or the sidelink; two (or more) UL signals associated with the IMD are from other radio (or sidelink) and the MCG; or two (or more) UL signals associated with the IMD are from other radio (or sidelink) and the SCG.

In some embodiments of the present disclosure, the IDC report may indicate frequency #2 based on the IDC configuration.

For example, in some embodiments of the present disclosure, UE 201 may select a radio frequency channel number from the at least one radio frequency channel number in the IDC configuration to represent frequency #2. For example, the IDC configuration may list a plurality of ARFCN values for a frequency to be detected. When an IDC problem is detected, UE 201 can select one ARFCN value from the plurality of ARFCN values to denote the affected frequency.

In some embodiments of the present disclosure, frequency #2 can be described based on the at least one radio frequency channel number and the frequency offset in the IDC configuration. In some embodiments, frequency #2 can be represented by the frequency offset and one of the at least one radio frequency channel number. For example, frequency #2 can be represented by “ARFCN value +frequency offset.” For example, the IDC report can indicate the ARFCN value and the frequency offset (optional). In some embodiments, frequency #2 can be represented by the frequency offset, a weighting value of the frequency offset, and one of the at least one radio frequency channel number. For example, frequency #2 can be represented by “ARFCN value+k×frequency offset.” For example, the IDC report can indicate the ARFCN value, the value of k, and the frequency offset (optional).

For example, for a to-be-detected frequency from 1800 MHZ to 1900 MHZ, the IDC configuration may include an ARFCN value denoting 1850 MHZ (i.e., the central frequency). When an IDC problem is detected at the bandwidth between 1820 MHZ to 1830 MHZ (i.e., the central frequency is 1825 MHZ), UE 201 may report the affected frequency as: ARFCN value (1850 MHZ)+offset (−25 MHZ). For example, the IDC report may include an ARFCN value denoting 1850 MHZ and an offset value denoting −25 MHZ. In another example, UE 201 may report the affected frequency as: ARFCN value (1850 MHZ)+5*offset (−5 MHZ). For example, the IDC report may include an ARFCN value denoting 1850 MHZ, a value indicating the weighting value 5, and an offset value denoting −5 MHZ.

In some embodiments of the present disclosure, UE 201 can report indexes of radio frequency channel numbers associated with frequency #2 among the at least one radio frequency channel number in the IDC configuration. For example, the IDC configuration may indicate 48 ARFCN values for a frequency with 100 M bandwidth. 6 bits can be used to index theses 48 ARFCN values. For example, the 48 ARFCN values can be indexed, from “0” to “47.” UE 201 can report indexes of the ARFCN values for an affected frequency to BS 202. Compared to directly indicating ARFCN values, this method can save signaling overhead.

In some embodiments of the present disclosure, the IDC report may indicate the bandwidth of frequency #2.

For example, various approaches may be employed to indicate a frequency region/range affected by IDC interference. For example, the affected frequency region may be indicated by a central frequency and a bandwidth of the actual affected frequency range (hereinafter, approach #1). For example, the affected frequency region may be indicated by a starting frequency and an ending frequency of the actual affected frequency range (hereinafter, approach #2). For example, the affected frequency region may be indicated by a starting frequency and a bandwidth of the actual affected frequency range (hereinafter, approach #3). The methods for indicating frequency #2 as described above may be applied to indicating the central frequency, the starting frequency or the ending frequency in the above approaches. For example, frequency #2 may refer to the central frequency, the starting frequency or the ending frequency in the above approaches.

In, for example, approach #1 and #3, the IDC report may indicate the bandwidth of the frequency (e.g., frequency #2) affected by the IDC interference. In some embodiments of the present disclosure, the bandwidth value included in the IDC report may be a half of the bandwidth of frequency #2 (e.g., a half of the actual bandwidth of the actual affected frequency range).

In some embodiments of the present disclosure, the bandwidth in the IDC report may be equal to or larger than a minimum bandwidth configured in the IDC configuration. For example, UE 201 may be configured with a minimum bandwidth of 5 MHZ. When UE 201 detects IDC interference within a bandwidth of 2 MHZ, the IDC report may indicate a bandwidth of 5 MHZ, instead of 2 MHZ. When UE 201 detects IDC interference within a bandwidth of 6 MHZ, the IDC report may indicate a bandwidth of 6 MHZ.

In some embodiments of the present disclosure, the IDC report may indicate the bandwidth of frequency #2 based on the IDC configuration.

For example, in some embodiments of the present disclosure, UE 201 may select a bandwidth value from the list of bandwidth values in the IDC configuration. For example, for approaches #1 and #3, the IDC report may indicate frequency #2 (e.g., a central frequency or a starting frequency) and the selected bandwidth value. In some examples, frequency #2 may be selected from at least one radio frequency channel number for a frequency to be detected. For example, when an IDC problem is detected at the bandwidth between 1820 MHZ to 1830 MHZ (the bandwidth is 10 MHZ), UE 201 may select a bandwidth value indicating 10 MHZ.

In some embodiments of the present disclosure, a bandwidth of frequency #2 can be described based on the minimum bandwidth and the incremental bandwidth in the IDC configuration. In some embodiments, the IDC report may include a weighting value of the incremental bandwidth. For example, the bandwidth of frequency #2 can be represented by “bandwidth #1+n1×bandwidth #2”. For example, the IDC report can indicate the value of n1.

In some embodiments of the present disclosure, a bandwidth of frequency #2 can be described based on the minimum bandwidth in the IDC configuration. In some embodiments, the IDC report may include a weighting value of the minimum bandwidth. For example, the bandwidth of frequency #2 can be represented by “n2>bandwidth #1”. For example, the IDC report can indicate the value of n2.

In some embodiments of the present disclosure, the IDC report may include cell group (CG) information (e.g., CG ID) associated with the IDC interference. For example, the IDC report may indicate the ID of the MCG or SCG affected by the IDC interference.

In some embodiments of the present disclosure, the IDC report may include direction information of the IDC interference.

For example, the direction information may indicate at least one of the following:
a) a victim of the IDC interference is an MCG configured for UE 201, or an MN of UE 201;
b) a victim of the IDC interference is an SCG configured for UE 201, or an SN of UE 201;
c) a victim of the IDC interference is a radio system based on a non-3GPP RAT (e.g., GNSS, WiFi, Bluetooth, etc.);
d) a victim of the IDC interference is a sidelink of UE 201;
e) a victim of the IDC interference includes the MCG and SCG of UE 201 or includes the MN and SN of UE 201;
f) a victim of the IDC interference includes the MCG of UE 201 and the sidelink of UE 201 or includes the MN of UE 201 and the sidelink of UE 201;
g) a victim of the IDC interference includes the MCG of UE 201 and the radio system based on a non-3GPP RAT or includes the MN of UE 201 and the radio system based on a non-3GPP RAT;
h) a victim of the IDC interference includes the SCG of UE 201 and the sidelink of UE 201 or includes the SN of UE 201 and the sidelink of UE 201;
i) a victim of the IDC interference includes the SCG of UE 201 and the radio system based on a non-3GPP RAT or includes the SN of UE 201 and the radio system based on a non-3GPP RAT;
j) a victim of the IDC interference includes the MCG and SCG of UE 201 and the sidelink of UE 201 or includes the MN and SN of UE 201 and the sidelink of UE 201; or
k) a victim of the IDC interference includes the MCG and SCG of UE 201 and the radio system based on a non-3GPP RAT or includes the MN and SN of UE 201 and the radio system based on a non-3GPP RAT.

In some examples, the above direct information (a)-(k) can be enumerated as {MCG, SCG, other, sidelink, MCG-SCG, MCG-sidelink, MCG-other, SCG-sidelink, SCG-other, MCG-SCG-sidelink, MCG-SCG-other}. In some examples, the above direct information (a)-(k) can be enumerated as {MN, SN, other, sidelink, MN-SN, MN-sidelink, MN-other, SN-sidelink, SN-other, MN-SN-sidelink, MN-SN-other}.

In some examples, the above direct information (a)-(k) can be denoted by one or more of the enumerated values of {MCG, SCG, other, sidelink} or {MN, SN, other, sidelink}. For example, direct information (a) can be denoted by {‘MCG’} and direct information (e) can be denoted by {‘MCG’ and ‘SCG’}.

In some embodiments of the present disclosure, UE 201 may receive an indication enabling IMD detection from BS 202 (e.g., the MN or SN). For example, UE 201 may receive at least one of the following: an indication (denoted as indication #1) enabling MN IMD detection; an indication (denoted as indication #2) enabling SN IMD detection; an indication (denoted as indication #3) enabling IMD detection between an MN and an SN; or an indication (denoted as indication #4) enabling sidelink IMD detection.

In some embodiments of the present disclosure, in response to receiving indication #1, UE 201 may consider itself to be configured to report IMD related information for the MN (or MCG) of UE 201. In some embodiments of the present disclosure, in response to receiving indication #2, UE 201 may consider itself to be configured to report IMD related information for the SN (or SCG) of UE 201. In some embodiments of the present disclosure, in response to receiving indication #3, UE 201 may consider itself to be configured to report IMD related information between the MN and the SN (e.g., the MCG and SCG) of UE 201. In some embodiments of the present disclosure, in response to receiving indication #4, UE 201 may consider itself to be configured to report IMD related information for a sidelink of UE 201.

As stated above, IMD signal may involves two UL signals from an aggressor RAT(s). “IMD detection between an MN and an SN” and “IMD related information between the MN and the SN” may refer to the case where the two UL signals are from MN and SN (or from MCG and SCG). Similarly, “MN IMD detection” and “IMD related information for the MN” may refer to the case where at least one of the two UL signal is from the MN (or MCG). “SN IMD detection” and “IMD related information for the SN” may refer to the case where at least one of the two UL signal is from the SN (or SCG). “Sidelink IMD detection” and “IMD related information for the sidelink” may refer to the case where at least one of the two UL signal is from the sidelink.

In response to receiving the IDC report from UE 201, BS 202 (e.g., the MN or the SN) may solve the reported IDC problem(s).

It should be appreciated by persons skilled in the art that the sequence of the operations in exemplary procedure 200 may be changed and that some of the operations in exemplary procedure 200 may be eliminated or modified, without departing from the spirit and scope of the disclosure.

FIG. 3 illustrates a flow chart of exemplary procedure 300 for avoiding IDC interference in accordance with some embodiments of the present disclosure. Details described in all of the foregoing embodiments of the present disclosure are applicable for the embodiments shown in FIG. 3.

Referring to FIG. 3, in operation 311, UE 301 may be in a connected state (e.g., RRC_CONNECTED state as specified in 3GPP specifications) and may access its serving BS(s) (e.g., BS 302 and BS 303). BS 302 and BS 303 may function as an MN and an SN of UE 301, respectively. In some embodiments, the MN and the SN of UE 301 may be the same BS. UE 301 may be configured with an MCG associated with BS 302 and an SCG associated with BS 303.

In some embodiments, UE 301 may transmit IDC related capability to its serving BS(s) (e.g., BS 302, BS 303 or both). The IDC related capability may indicate at least one of the following: whether UE 301 supports IDC for DC; whether UE 301 supports IDC for SCG; or whether UE 301 supports IDC for IMD in DC.

In operation 313, BS 303 may transmit an IDC configuration (denoted as IDC configuration #2) associated with the SCG of UE 301 to BS 302. IDC configuration #2 may be transmitted via an Xn interface. The descriptions with respect to the IDC configuration in the foregoing embodiments can be applied to IDC configuration #2.

For example, IDC configuration #2 may include information of a frequency (e.g., frequency #1) to be detected by UE 301. For example, IDC configuration #2 may indicate at least one of: at least one radio frequency channel number for the frequency to be detected; a bandwidth of the frequency to be detected (e.g., the bandwidth corresponding to a non-serving frequency); or a frequency offset relative to the at least one radio frequency channel number.

For example, IDC configuration #2 may list a plurality of ARFCN values for each frequency to be detected. For example, IDC configuration #2 may include a single ARFCN value for each frequency to be detected. In some embodiments, for each non-serving frequency, IDC configuration #2 may further include a corresponding bandwidth to be applied to the non-serving frequency. For example, IDC configuration #2 may include a frequency offset that can be applied to the radio frequency channel number(s). In another example, the frequency offset may be predefined (e.g., in a standard(s)) or preconfigured.

For example, IDC configuration #2 may include the bandwidth information for IDC interference detection and/or reporting. For example, IDC configuration #2 may indicate at least one of: a list of bandwidths for IDC reporting; a minimum bandwidth for IDC reporting (e.g., bandwidth #1); or the minimum bandwidth and an incremental bandwidth (e.g., bandwidth #2).

In operation 315, BS 302 may transmit an IDC configuration to UE 301. The IDC configuration may include an IDC configuration (denoted as IDC configuration #1) associated with the MCG of UE 301, an IDC configuration (e.g., IDC configuration #2) associated with the SCG of UE 301, or both. The descriptions with respect to the IDC configuration in the foregoing embodiments can be applied to IDC configuration #1.

For example, IDC configuration #1 may include information of a frequency (e.g., frequency #1) to be detected by UE 301. For example, IDC configuration #1 may indicate at least one of: at least one radio frequency channel number for the frequency to be detected; a bandwidth of the frequency to be detected (e.g., the bandwidth corresponding to a non-serving frequency); or a frequency offset relative to the at least one radio frequency channel number.

For example, IDC configuration #1 may list a plurality of ARFCN values for each frequency to be detected. For example, IDC configuration #1 may include a single ARFCN value for each frequency to be detected. In some embodiments, for each non-serving frequency, IDC configuration #1 may further include a corresponding bandwidth to be applied to the non-serving frequency. For example, IDC configuration #1 may include a frequency offset that can be applied to the radio frequency channel number(s). In another example, the frequency offset may be predefined (e.g., in a standard(s)) or preconfigured.

For example, IDC configuration #1 may include the bandwidth information for IDC interference detection and/or reporting. For example, IDC configuration #1 may indicate at least one of: a list of bandwidths for IDC reporting; a minimum bandwidth for IDC reporting (e.g., bandwidth #1); or the minimum bandwidth and an incremental bandwidth (e.g., bandwidth #2).

In some embodiments of the present disclosure, BS 302 or BS 303 may transmit an indication enabling IMD detection to UE 301. For example, BS 302 or BS 303 may transmit at least one of the following to UE 301: an indication (denoted as indication #1′) enabling MN IMD detection; an indication (denoted as indication #2′) enabling SN IMD detection; an indication (denoted as indication #3′) enabling IMD detection between an MN and an SN; or an indication (denoted as indication #4′) enabling sidelink IMD detection.

Indication #1′ can configure UE 301 to report IMD related information for BS 302. Indication #2′ can configure UE 301 to report IMD related information for BS 303. Indication #3′ can configure UE 301 to report IMD related information between BS 302 and BS 303. Indication #4′ can configure UE 301 to report IMD related information for a sidelink of UE 301.

In operation 317, UE 301 may detect IDC interference based on the received IDC configuration(s) (e.g., IDC configuration #1 and IDC configuration #2). In some embodiments, UE 301 may detect IDC interference (e.g., an IDC problem). In operation 319, UE 301 may transmit an IDC report to BS 302 in response to detecting the IDC interference. For example, UE 301 may report IDC related information when an IDC problem is detected and cannot be solved by UE 301. The IDC report may indicate a frequency (e.g., frequency #2) affected by the IDC interference. The affected frequency may include at least one serving frequency, at least one non-serving frequency, or both. The affected frequency may be associated with an MCG frequency, an SCG frequency, or both.

The descriptions with respect to the IDC report in the foregoing embodiments can be applied here.

For example, the IDC report may indicate one or more affected frequencies (e.g., frequency #2).

For example, UE 301 may select a radio frequency channel number from the at least one radio frequency channel number in the IDC configuration. For example, the IDC configuration may list a plurality of ARFCN values for a frequency to be detected. When an IDC problem is detected, UE 301 can select one ARFCN value from the plurality of ARFCN values to denote the affected frequency.

For example, the affected frequency can be described based on the at least one radio frequency channel number and the frequency offset in the IDC configuration. For example, the affected frequency can be represented by the frequency offset and one of the at least one radio frequency channel number (e.g., “ARFCN value+frequency offset”). The IDC report can indicate the ARFCN value and the frequency offset (optional). For example, the affected frequency can be represented by the frequency offset, a weighting value of the frequency offset, and one of the at least one radio frequency channel number (e.g., “ARFCN value+k×frequency offset”). The IDC report can indicate the ARFCN value, the value of k, and the frequency offset (optional)

For example, the affected frequency can be indicated by indexes of radio frequency channel numbers associated with the affected frequency among the at least one radio frequency channel number in the IDC configuration.

The affected frequency may refer to the central frequency, the starting frequency or the ending frequency of a frequency region/range affected by IDC interference.

For example, the IDC report may indicate the bandwidth of the affected frequency (e.g., frequency #2).

For example, UE 301 may select a bandwidth value from the list of bandwidth values in the IDC configuration. For example, a bandwidth of the affected frequency can be described based on the minimum bandwidth and the incremental bandwidth in the IDC configuration (e.g., “bandwidth #1+n1×bandwidth #2”). In some embodiments, the IDC report may include a weighting value of the incremental bandwidth (e.g., n1). For example, a bandwidth of the affected frequency can be described based on the minimum bandwidth in the IDC configuration (e.g., “n2×bandwidth #1”). In some embodiments, the IDC report may include a weighting value of the minimum bandwidth (e.g., n2).

In some embodiments of the present disclosure, the bandwidth value included in the IDC report may be a half of the bandwidth of the affected frequency. In some embodiments of the present disclosure, the bandwidth in the IDC report may be equal to or larger than a minimum bandwidth configured in the IDC configuration.

In some embodiments of the present disclosure, the IDC report may include direction information of the IDC interference. For example, the direction information may indicate at least one of direct information (a)-(k) as mentioned above.

In some embodiments of the present disclosure, the IDC report may include at least one of the following: a list of frequencies affected by the IDC interference; a bandwidth(s) corresponding to the list of frequencies; a CG ID(s) associated with the IDC interference; or a victim type(s) of the IDC interference.

In response to receiving the IDC report from UE 301, BS 302 may try to solve the reported IDC problem(s) in the IDC report in operation 321. When BS 302 is unable to solve an IDC problem in the IDC report (e.g., the IDC problem is associated with BS 303), BS 302 may transmit a message (denoted as message #1) associated with this IDC problem to BS 303 in operation 323.

For example, the IDC problem is associated with both the MCG and SCG of UE 301 and BS 302 cannot solve it. BS 302 may request BS 303 to solve it. For instance, two (or more) UL signals associated with the IMD are from the MCG and SCG.

For example, the IDC problem is associated with the SCG of UE 301. BS 302 may request BS 303 to solve it. For instance, two (or more) UL signals associated with the IMD are from the MCG and SCG.

For example, the IDC problem is associated with the SCG of UE 301 and a sidelink of UE 301, or is associated with the SCG of UE 301 and a radio under a non-3GPP RAT. BS 302 may request BS 303 to solve it. For instance, two (or more) UL signals associated with the IMD are from the SCG and the sidelink (or the radio under a non-3GPP RAT).

In some embodiments of the present disclosure, message #1 may be based on the IDC report from UE 301. In some embodiments of the present disclosure, message #1 may indicate at least one of the following: a list of frequencies affected by the IDC problem (e.g., from the IDC report); a bandwidth(s) corresponding to the list of frequencies (e.g., from the IDC report); a CG ID (e.g., MCG or SCG) associated with the IDC problem (e.g., from the IDC report); a victim type of the IDC problem (e.g., from the IDC report); a suggestion for solving the IDC problem; or a cause of the IDC problem.

For example, the suggestion may include “serving cell change” or “removing a SCell.” The SN may act upon the suggestion or take different action to solve the IDC problem. For example, the cause may indicate “IDC interference” or “IMD between MN and SN.”

BS 303 may try to solve the reported IDC problem. In operation 325, BS 303 may transmit, to BS 302, a response indicating whether the IDC problem is solved by BS 303 or not. The indication is transmitted via an Xn interface.

In exemplary procedure 300, BS 302 (MN) configures the IDC configuration. For example, regardless of whether BS 303 (SN) and UE 301 has established an SRB (e.g., split SRB1 or SRB3) or not, BS 303 may not directly transmit the IDC configuration associated with the SCG to UE 301. BS 303 may transmit the IDC configuration associated with the SCG of UE 301 to BS 302, which can configure it to UE 301.

In exemplary procedure 300, BS 302 (MN) handles the IDC problem(s). For example, UE 301 may transmit the IDC report to BS 302, which may try to solve the IDC problem(s) indicated in the IDC report. When, for example, an IDC problem cannot be solved by BS 302, BS 302 may then request BS 303 to solve it.

It should be appreciated by persons skilled in the art that the sequence of the operations in exemplary procedure 300 may be changed and that some of the operations in exemplary procedure 300 may be eliminated or modified, without departing from the spirit and scope of the disclosure.

FIG. 4 illustrates a flow chart of exemplary procedure 400 for avoiding IDC interference in accordance with some embodiments of the present disclosure. Details described in all of the foregoing embodiments of the present disclosure are applicable for the embodiments shown in FIG. 4.

Referring to FIG. 4, in operation 411, UE 401 may be in a connected state (e.g., RRC_CONNECTED state as specified in 4GPP specifications) and may access its serving BS(s) (e.g., BS 402 and BS 403). BS 402 and BS 403 may function as an MN and an SN of UE 401, respectively. In some embodiments, the MN and the SN of UE 401 may be the same BS. UE 401 may be configured with an MCG associated with BS 402 and an SCG associated with BS 403.

In some embodiments, UE 401 may transmit IDC related capability to its serving BS(s) (e.g., BS 402, BS 403 or both). The IDC related capability may indicate at least one of the following: whether UE 401 supports IDC for DC; whether UE 401 supports IDC for SCG; or whether UE 401 supports IDC for IMD in DC.

In operation 413, BS 403 may transmit an IDC configuration (denoted as IDC configuration #2′) associated with the SCG of UE 401 to UE 401. The IDC configuration may be transmitted via the Uu interface, for example, via an SRB (e.g., split SRB1 or SRB3) between UE 401 and BS 403. The descriptions with respect to IDC configuration #2 in the foregoing embodiments can be applied to IDC configuration #2′.

For example, IDC configuration #2′ may include information of a frequency (e.g., frequency #1) to be detected by UE 401. For example, IDC configuration #2′ may indicate at least one of: at least one radio frequency channel number for the frequency to be detected; a bandwidth of the frequency to be detected (e.g., the bandwidth corresponding to a non-serving frequency); or a frequency offset relative to the at least one radio frequency channel number.

For example, IDC configuration #2′ may list a plurality of ARFCN values for each frequency to be detected. For example, IDC configuration #2′ may include a single ARFCN value for each frequency to be detected. In some embodiments, for each non-serving frequency, IDC configuration #2′ may further include a corresponding bandwidth to be applied to the non-serving frequency. For example, IDC configuration #2′ may include a frequency offset that can be applied to the radio frequency channel number(s). In another example, the frequency offset may be predefined (e.g., in a standard(s)) or preconfigured.

For example, IDC configuration #2′ may include the bandwidth information for IDC interference detection and/or reporting. For example, IDC configuration #2′ may indicate at least one of: a list of bandwidths for IDC reporting; a minimum bandwidth for IDC reporting (e.g., bandwidth #1); or the minimum bandwidth and an incremental bandwidth (e.g., bandwidth #2).

In operation 415, BS 402 may transmit an IDC configuration (denoted as IDC configuration #1′) associated with the MCG of UE 401 to UE 401 via the Uu interface (e.g., via SRB1 or SRB2). The descriptions with respect to IDC configuration #1 in the foregoing embodiments can be applied to IDC configuration #1′.

For example, IDC configuration #1′ may include information of a frequency (e.g., frequency #1) to be detected by UE 401. For example, IDC configuration #1′ may indicate at least one of: at least one radio frequency channel number for the frequency to be detected; a bandwidth of the frequency to be detected (e.g., the bandwidth corresponding to a non-serving frequency); or a frequency offset relative to the at least one radio frequency channel number.

For example, IDC configuration #1′ may list a plurality of ARFCN values for each frequency to be detected. For example, IDC configuration #1′ may include a single ARFCN value for each frequency to be detected. In some embodiments, for each non-serving frequency, IDC configuration #1′ may further include a corresponding bandwidth to be applied to the non-serving frequency. For example, IDC configuration #1′ may include a frequency offset that can be applied to the radio frequency channel number(s). In another example, the frequency offset may be predefined (e.g., in a standard(s)) or preconfigured.

For example, IDC configuration #1′ may include the bandwidth information for IDC interference detection and/or reporting. For example, IDC configuration #1′ may indicate at least one of: a list of bandwidths for IDC reporting; a minimum bandwidth for IDC reporting (e.g., bandwidth #1); or the minimum bandwidth and an incremental bandwidth (e.g., bandwidth #2).

In some embodiments of the present disclosure, BS 402 or BS 403 may transmit an indication enabling IMD detection to UE 401 via the Uu interface. For example, BS 403 may transmit such indication to UE 401 via the SRB3 or the split SRB1. For example, BS 402 or BS 403 may transmit at least one of the following to UE 401: an indication (e.g., indication #1′) enabling MN IMD detection; an indication (e.g., indication #2′) enabling SN IMD detection; an indication (e.g., indication #4′) enabling IMD detection between an MN and an SN; or an indication (e.g., indication #4′) enabling sidelink IMD detection. For example, BS 403 may transmit at least one of indication #2′, indication #3′, or indication #4′ to UE 401.

Indication #1′ can configure UE 401 to report IMD related information for BS 402. Indication #2′ can configure UE 401 to report IMD related information for BS 403. Indication #4′ can configure UE 401 to report IMD related information between BS 402 and BS 403. Indication #4′ can configure UE 401 to report IMD related information for a sidelink of UE 401.

In operation 417, UE 401 may detect IDC interference based on the received IDC configuration(s) (e.g., IDC configuration #1 and IDC configuration #2). UE 401 may transmit an IDC report in response to detecting the IDC interference (e.g., an IDC problem). For example, UE 401 may report IDC related information when an IDC problem is detected and cannot be solved by UE 401. As will be described in details later, the IDC report may be transmitted to both BS 402 and BS 403 or one of BS 402 and BS 403.

The IDC report may indicate a frequency (e.g., frequency #2) affected by the IDC interference. The affected frequency may include at least one serving frequency, at least one non-serving frequency, or both. The affected frequency may be associated with an MCG frequency, an SCG frequency, or both. The descriptions with respect to the IDC report in the foregoing embodiments can be applied here.

For example, the IDC report may indicate one or more affected frequencies (e.g., frequency #2).

For example, UE 401 may select a radio frequency channel number from the at least one radio frequency channel number in the IDC configuration. For example, the IDC configuration may list a plurality of ARFCN values for a frequency to be detected. When an IDC problem is detected, UE 401 can select one ARFCN value from the plurality of ARFCN values to denote the affected frequency.

For example, the affected frequency can be described based on the at least one radio frequency channel number and the frequency offset in the IDC configuration. For example, the affected frequency can be represented by the frequency offset and one of the at least one radio frequency channel number (e.g., “ARFCN value+frequency offset”). The IDC report can indicate the ARFCN value and the frequency offset (optional). For example, the affected frequency can be represented by the frequency offset, a weighting value of the frequency offset, and one of the at least one radio frequency channel number (e.g., “ARFCN value+k×frequency offset”). The IDC report can indicate the ARFCN value, the value of k, and the frequency offset (optional)

For example, the affected frequency can be indicated by indexes of radio frequency channel numbers associated with the affected frequency among the at least one radio frequency channel number in the IDC configuration.

The affected frequency may refer to the central frequency, the starting frequency or the ending frequency of a frequency region/range affected by IDC interference.

For example, the IDC report may indicate the bandwidth of the affected frequency (e.g., frequency #2).

For example, UE 401 may select a bandwidth value from the list of bandwidth values in the IDC configuration. For example, a bandwidth of the affected frequency can be described based on the minimum bandwidth and the incremental bandwidth in the IDC configuration (e.g., “bandwidth #1+n1×bandwidth #2”). In some embodiments, the IDC report may include a weighting value of the incremental bandwidth (e.g., n1). For example, a bandwidth of the affected frequency can be described based on the minimum bandwidth in the IDC configuration (e.g., “n2×bandwidth #1”). In some embodiments, the IDC report may include a weighting value of the minimum bandwidth (e.g., n2).

In some embodiments of the present disclosure, the bandwidth value included in the IDC report may be a half of the bandwidth of the affected frequency. In some embodiments of the present disclosure, the bandwidth in the IDC report may be equal to or larger than a minimum bandwidth configured in the IDC configuration.

In some embodiments of the present disclosure, the IDC report may include direction information of the IDC interference. For example, the direction information may indicate at least one of direct information (a)-(k) as mentioned above.

In some embodiments of the present disclosure, the IDC report may include at least one of the following: a list of frequencies affected by the IDC interference; a bandwidth(s) corresponding to the list of frequencies; a CG ID(s) associated with the IDC interference; or a victim type(s) of the IDC interference.

In some embodiments of the present disclosure, UE 401 may transmit an IDC report to both BS 402 and BS 403. For example, referring to procedure 420, UE 401 may transmit an IDC report (denoted as IDC report #1) to BS 402 in operation 421. In operation 423, UE 401 may transmit an IDC report (denoted as IDC report #2) to BS 403 via the Uu interface, for example, via the split SRB1 or SRB3.

In some examples, IDC report #1 and IDC report #2 may be the same. For example, both IDC report #1 and IDC report #2 may include all the IDC problems detected at UE 401. In some examples, IDC report #1 and IDC report #2 may be different. For example, IDC report #2 may only include the IDC problems associated with BS 403 (or the SCG of UE 401) and detected at UE 401, and IDC report #1 may include the remaining types of IDC problems detected at UE 401. For example, IDC report #2 may only include the IDC problems associated with BS 403 (or the SCG of UE 401), and IDC report #1 may include all the IDC problems detected at UE 401. For example, IDC report #1 may only include IDC problems associated with BS 402 (or the MCG of UE 401) and detected at UE 401, and IDC report #2 may include the remaining types or all of the IDC problems detected at UE 401.

The descriptions with respect to the IDC report in the foregoing embodiments can be applied to IDC report #1 and IDC report #2. For example, IDC report #1 or IDC report #2 may include at least one of the following: a list of frequencies affected by the IDC interference; a bandwidth(s) corresponding to the list of frequencies; a CG ID(s) associated with the IDC interference; or a victim type(s) of the IDC interference.

In response to receiving the respective IDC reports from UE 401, BS 402 and BS 403 may try to solve the reported IDC problems in the IDC reports. In some examples, when one of the two BSs solves an IDC problem, this BS may, in operation 425, inform the other BS that the IDC problem is solved. For example, BS 402 (or BS 403) may inform BS 403 (or BS 402) that an IDC problem is solved by BS 402 (or BS 403).

In some examples, when one of the two BSs is unable to solve an IDC problem, this BS may transmit a message (denoted as message #1′) associated with this IDC problem to the other BS in operation 425. The other BS may try to solve the reported IDC problem and may respond with an indication indicating whether the IDC problem is solved or not via the Xn interface.

For example, BS 402 (or BS 403) may transmit, to BS 403 (or BS 402), a message indicating that BS 402 (or BS 403) is unable to solve an IDC problem. For instance, in response to BS 402 (or BS 403) being unable to solve an IDC problem, BS 402 (or BS 403) may transmit such message to BS 403 (or BS 402). BS 403 (or BS 402) may transmit, to BS 402 (or BS 403), a response to the message, indicating whether the reported IDC problem is solved or not.

The descriptions with respect to message #1 in the foregoing embodiments can be applied to message #1′. For example, message #1′ may indicate at least one of the following: a list of frequencies affected by the IDC problem (e.g., from the IDC report); a bandwidth(s) corresponding to the list of frequencies (e.g., from the IDC report); a CG ID (e.g., MCG or SCG) associated with the IDC problem (e.g., from the IDC report); a victim type of the IDC problem (e.g., from the IDC report); a suggestion for solving the IDC problem; or a cause of the IDC problem.

In some embodiments of the present disclosure, UE 401 may transmit an IDC report to one of BS 402 and BS 403.

For example, referring to procedure 430, UE 401 may transmit an IDC report to BS 402 in operation 431. Operations 431 to 437 may be similar to operations 319 to 325. For example, in operation 433, BS 402 may try to solve the IDC problem(s) in the IDC report. In operation 435, BS 402 may request BS 403 to solve a specific IDC problem(s) in the IDC report (e.g., by transmitting an IDC report such as message #1 or message #1′ via the Xn interface). For example, BS 402 cannot solve the IDC problem(s). In operation 437, BS 403 may transmit, to BS 402, a response indicating whether the IDC problem(s) is solved or not.

For example, referring to procedure 450, UE 401 may, in operation 451, transmit an IDC report to BS 403 via the Uu interface, for example, via the split SRB1 or SRB3. Operations 451 to 457 may be similar to operations 431 to 437 and operations 319 to 325. For example, in operation 453, BS 403 may try to solve the IDC problem(s) in the IDC report. In operation 455, BS 403 may request BS 402 to solve a specific IDC problem(s) in the IDC report (e.g., by transmitting an IDC report such as message #1 or message #1′ via the Xn interface). For example, BS 403 cannot solve the IDC problem(s). In operation 457, BS 402 may transmit, to BS 403, a response indicating whether the IDC problem(s) is solved or not.

In exemplary procedure 400, both BS 402 (MN) and BS 403 (SN) can configure an IDC configuration to UE 401, and can handle the IDC problems.

It should be appreciated by persons skilled in the art that the sequence of the operations in exemplary procedure 400 may be changed and that some of the operations in exemplary procedure 400 may be eliminated or modified, without departing from the spirit and scope of the disclosure.

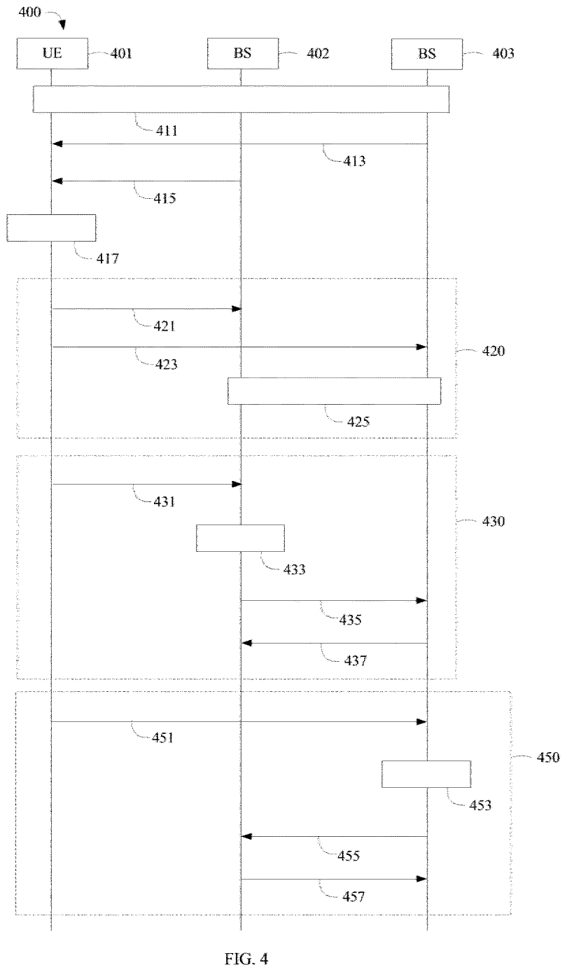

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE.

Referring to FIG. 5, in operation 511, a UE may receive an IDC configuration from a BS, wherein the IDC configuration is associated with a first frequency to be detected by the UE, and the first frequency includes at least one serving frequency, at least one non-serving frequency, or both. The BS may be an MN or an SN of the UE.

In operation 513, the UE may detect IDC interference based on the configuration. For example, the UE may detect whether there is IDC interference or IDC problem on the first frequency. In operation 517, the UE may transmit an IDC report to the BS in response to detecting the IDC interference.

In some embodiments of the present disclosure, the IDC configuration indicates at least one of: at least one radio frequency channel number for the first frequency to be detected by the UE; or a frequency offset relative to the at least one radio frequency channel number.

In some embodiments of the present disclosure, the IDC report indicates a second frequency affected by the IDC interference, and the second frequency is represented by: the frequency offset and one of the at least one radio frequency channel number; the frequency offset, a weighting value of the frequency offset, and one of the at least one radio frequency channel number; or indexes of radio frequency channel numbers associated with the second frequency among the at least one radio frequency channel number.

In some embodiments of the present disclosure, the IDC configuration indicates a minimum bandwidth for IDC reporting, or the minimum bandwidth and an incremental bandwidth.

In some embodiments of the present disclosure, the IDC report indicates a second frequency affected by the IDC interference, and a bandwidth of the second frequency is based on the minimum bandwidth or both the minimum bandwidth and the incremental bandwidth. In some embodiments of the present disclosure, the IDC report includes a weighting value of the minimum bandwidth or a weighting value of the incremental bandwidth.

In some embodiments of the present disclosure, the UE may receive at least one of the following from the BS: a first indication enabling MN IMD detection; a second indication enabling SN IMD detection; a third indication enabling IMD detection between an MN and an SN; or a fourth indication enabling sidelink IMD detection.

In some embodiments of the present disclosure, the UE may perform at least one of the following: in response to receiving the first indication, determining to report IMD related information for an MN of the UE; in response to receiving the second indication, determining to report IMD related information for an SN of the UE; in response to receiving the third indication, determining to report IMD related information between the MN and the SN of the UE; or in response to receiving the fourth indication, determining to report IMD related information for a sidelink of the UE.

In some embodiments of the present disclosure, the IDC report includes direction information of the IDC interference. In some embodiments of the present disclosure, the direction information of the IDC interference indicates at least one of the following: a victim of the IDC interference is an MCG configured for the UE; a victim of the IDC interference is an SCG configured for the UE; a victim of the IDC interference is a radio system based on a non-3GPP RAT; a victim of the IDC interference is a sidelink of the UE; a victim of the IDC interference includes the MCG and SCG of the UE; a victim of the IDC interference includes the MCG of the UE and the sidelink of the UE; a victim of the IDC interference includes the MCG of the UE and the radio system based on a non-3GPP RAT; a victim of the IDC interference includes the SCG of the UE and the sidelink of the UE; a victim of the IDC interference includes the SCG of the UE and the radio system based on a non-3GPP RAT; a victim of the IDC interference includes the MCG and SCG of the UE and the sidelink of the UE; or a victim of the IDC interference includes the MCG and SCG of the UE and the radio system based on a non-3GPP RAT.

In some embodiments of the present disclosure, the UE may transmit IDC related capability to the BS. The IDC related capability may indicate at least one of the following: whether the UE supports IDC assistance information for DC; whether the UE supports IDC assistance information for a SCG configured for the UE; or whether the UE supports IDC assistance information for IMD detection in DC.

It should be appreciated by persons skilled in the art that the sequence of the operations in exemplary procedure 500 may be changed and that some of the operations in exemplary procedure 500 may be eliminated or modified, without departing from the spirit and scope of the disclosure.

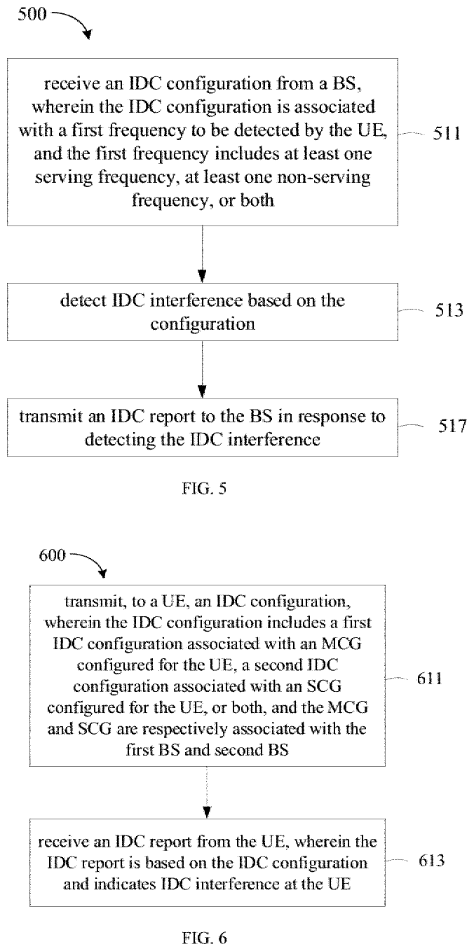

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a BS (e.g., an MN).

Referring to FIG. 6, in operation 611, a first BS may transmit, to a UE, an IDC configuration, wherein the IDC configuration includes a first IDC configuration associated with an MCG configured for the UE, a second IDC configuration associated with an SCG configured for the UE, or both, and the MCG and SCG are respectively associated with the first BS and second BS. For example, the first BS may be BS 102 in FIG. 1, BS 202 in FIG. 2, BS 302 in FIG. 3 or BS 402 in FIG. 4. The second BS may be BS 102 in FIG. 1, BS 202 in FIG. 2, BS 303 in FIG. 3 or BS 403 in FIG. 4.

In operation 613, the first BS may receive an IDC report from the UE, wherein the IDC report is based on the IDC configuration and indicates IDC interference at the UE.

In some embodiments of the present disclosure, at least one of the first IDC configuration or the second IDC configuration indicates at least one of: at least one radio frequency channel number for a first frequency to be detected by the UE; a bandwidth of the first frequency; or a frequency offset relative to the at least one radio frequency channel number.

In some embodiments of the present disclosure, at least one of the first IDC configuration or the second IDC configuration indicates at least one of: a list of bandwidths for IDC reporting; a minimum bandwidth for IDC reporting; or the minimum bandwidth and an incremental bandwidth.

In some embodiments of the present disclosure, the first BS may receive the second IDC configuration from the second BS via an Xn interface.

In some embodiments of the present disclosure, the IDC report includes at least one of the following: a list of frequencies affected by the IDC interference; a bandwidth(s) corresponding to the list of frequencies; a CG ID associated with the IDC interference; or a victim type of the IDC interference.

In some embodiments of the present disclosure, the first BS may perform at least one of the following: transmitting a first message to the second BS in response to the first BS being unable to solve an IDC problem in the IDC report; informing the second BS that an IDC problem in the IDC report is solved by the first BS; receiving, from the second BS, an indication that an IDC problem in the IDC report is solved by the second BS; or receiving, from the second BS, a second message indicating that the second BS is unable to solve an IDC problem in the IDC report.

In some embodiments of the present disclosure, at least one of the first message or the second message includes at least one of the following: a list of frequencies affected by the IDC problem; a bandwidth(s) corresponding to the list of frequencies; a CG ID associated with the IDC problem; a victim type of the IDC problem; a suggestion for solving the IDC problem; or a cause of the IDC problem.

In some embodiments of the present disclosure, the first BS may perform at least one of the following: receiving a first response to the first message, wherein the first response indicates whether the IDC problem is solved or not; or transmitting a second response to the second message, wherein the second response indicates whether the IDC problem is solved or not.

In some embodiments of the present disclosure, the IDC report indicates a second frequency affected by the IDC interference. In some embodiments, the second frequency is represented by the frequency offset and one of the at least one radio frequency channel number. In some embodiments, the second frequency is represented by the frequency offset, a weighting value of the frequency offset, and one of the at least one radio frequency channel number. In some embodiments, the second frequency is represented by indexes of radio frequency channel numbers associated with the second frequency among the at least one radio frequency channel number.

In some embodiments of the present disclosure, the IDC report indicates a second frequency affected by the IDC interference, and a bandwidth of the second frequency is based on the minimum bandwidth or both the minimum bandwidth and the incremental bandwidth. In some embodiments of the present disclosure, the IDC report includes a weighting value of the minimum bandwidth or a weighting value of the incremental bandwidth.

In some embodiments of the present disclosure, the first BS may transmit at least one of the following to the UE: a first indication enabling MN IMD detection; a second indication enabling SN IMD detection; a third indication enabling IMD detection between an MN and an SN; or a fourth indication enabling sidelink IMD detection.

In some embodiments of the present disclosure, the first indication configures the UE to report IMD related information for the first BS. In some embodiments of the present disclosure, the second indication configures the UE to report IMD related information for the second BS. In some embodiments of the present disclosure, the third indication configures the UE to report IMD related information between the first BS and the second BS. In some embodiments of the present disclosure, the fourth indication configures the UE to report IMD related information for a sidelink of the UE.

In some embodiments of the present disclosure, the IDC report includes direction information of the IDC interference.

In some embodiments of the present disclosure, the direction information of the IDC interference indicates at least one of the following: a victim of the IDC interference is the MCG; a victim of the IDC interference is the SCG; a victim of the IDC interference is a radio system based on a non-3GPP RAT; a victim of the IDC interference is a sidelink of the UE; a victim of the IDC interference includes the MCG and SCG; a victim of the IDC interference includes the MCG and the sidelink of the UE; a victim of the IDC interference includes the MCG and the radio system based on a non-3GPP RAT; a victim of the IDC interference includes the SCG and the sidelink of the UE; a victim of the IDC interference includes the SCG and the radio system based on a non-3GPP RAT; a victim of the IDC interference includes the MCG and SCG and the sidelink of the UE; or a victim of the IDC interference includes the MCG and SCG and the radio system based on a non-3GPP RAT.

In some embodiments of the present disclosure, the first BS may receive IDC related capability from the UE. The IDC related capability may indicate at least one of the following: whether the UE supports IDC assistance information for DC; whether the UE supports IDC assistance information for a SCG configured for the UE; or whether the UE supports IDC assistance information for IMD detection in DC.

It should be appreciated by persons skilled in the art that the sequence of the operations in exemplary procedure 600 may be changed and that some of the operations in exemplary procedure 600 may be eliminated or modified, without departing from the spirit and scope of the disclosure.

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a BS (e.g., an SN).

Referring to FIG. 7, in operation 711, a second BS may transmit, to a first BS or a UE, an IDC configuration, wherein the UE is configured with an MCG associated with the first BS and an SCG associated with the second BS, and the IDC configuration is associated with the SCG. For example, the first BS may be BS 102 in FIG. 1, BS 202 in FIG. 2, BS 302 in FIG. 3 or BS 402 in FIG. 4. The second BS may be BS 102 in FIG. 1, BS 202 in FIG. 2, BS 303 in FIG. 3 or BS 403 in FIG. 4.

In operation 713, the second BS may receive an IDC report from the first BS or the UE, wherein the IDC report is based on the IDC configuration and indicates IDC interference at the UE.

In some embodiments of the present disclosure, the second BS may perform at least one of the following: transmitting the IDC configuration to the UE via SRB3 or split SRB1 between the UE and the second BS; transmitting the IDC configuration to the first BS via an Xn interface; receiving the IDC report from the UE via the SRB3 or the split SRB1; or receiving the IDC report from the first BS via the Xn interface.

In some embodiments of the present disclosure, the IDC configuration indicates at least one of: at least one radio frequency channel number for a first frequency to be detected by the UE; a bandwidth of the first frequency; or a frequency offset relative to the at least one radio frequency channel number.

In some embodiments of the present disclosure, the IDC report indicates a second frequency affected by the IDC interference, and the second frequency is represented by: the frequency offset and one of the at least one radio frequency channel number; the frequency offset, a weighting value of the frequency offset, and one of the at least one radio frequency channel number; or indexes of radio frequency channel numbers associated with the second frequency among the at least one radio frequency channel number.

In some embodiments of the present disclosure, the IDC configuration indicates at least one of: a list of bandwidths for IDC reporting; a minimum bandwidth for IDC reporting; or the minimum bandwidth and an incremental bandwidth.

In some embodiments of the present disclosure, the IDC report indicates a second frequency affected by the IDC interference, and a bandwidth of the second frequency is based on: the list of bandwidths; the minimum bandwidth; or the minimum bandwidth and the incremental bandwidth.

In some embodiments of the present disclosure, the IDC report includes a weighting value of the minimum bandwidth or a weighting value of the incremental bandwidth.

In some embodiments of the present disclosure, the second BS may perform at least one of the following: receiving, from the first BS, a first message indicating that the first BS is unable to solve an IDC problem in the IDC report; receiving, from the first BS, an indication that an IDC problem in the IDC report is solved by the first BS; transmitting, to the first BS, an indication that an IDC problem in the IDC report is solved by the second BS; or transmitting, to the first BS, a second message indicating that the second BS is unable to solve an IDC problem in the IDC report.

In some embodiments of the present disclosure, at least one of the first message or the second message includes at least one of the following: a list of frequencies affected by the IDC problem; a bandwidth(s) corresponding to the list of frequencies; a CG ID associated with the IDC problem; a victim type of the IDC problem; a suggestion for solving the IDC problem; or a cause of the IDC problem.

In some embodiments of the present disclosure, the second BS may perform at least one of the following: transmitting a first response to the first message, wherein the first response indicates whether the IDC problem is solved or not; or receiving a second response to the second message, wherein the second response indicates whether the IDC problem is solved or not.

In some embodiments of the present disclosure, the second BS may transmit at least one of the following to the UE: a second indication enabling SN IMD detection; a third indication enabling IMD detection between a MN and an SN; or a fourth indication enabling sidelink IMD detection.

In some embodiments of the present disclosure, the second indication configures the UE to report IMD related information for the second BS. In some embodiments of the present disclosure, the third indication configures the UE to report IMD related information between the first BS and the second BS. In some embodiments of the present disclosure, the fourth indication configures the UE to report IMD related information for a sidelink of the UE.

In some embodiments of the present disclosure, the IDC report includes direction information of the IDC interference.

In some embodiments of the present disclosure, the direction information of the IDC interference indicates at least one of the following: a victim of the IDC interference is the MCG; a victim of the IDC interference is the SCG; a victim of the IDC interference is a radio system based on a non-3GPP RAT; a victim of the IDC interference is a sidelink of the UE; a victim of the IDC interference includes the MCG and SCG; a victim of the IDC interference includes the MCG and the sidelink of the UE; a victim of the IDC interference includes the MCG and the radio system based on a non-3GPP RAT; a victim of the IDC interference includes the SCG and the sidelink of the UE; a victim of the IDC interference includes the SCG and the radio system based on a non-3GPP RAT; a victim of the IDC interference includes the MCG and SCG and the sidelink of the UE; or a victim of the IDC interference includes the MCG and SCG and the radio system based on a non-3GPP RAT.

In some embodiments of the present disclosure, the second BS may receive IDC related capability from the UE. The IDC related capability may indicate at least one of the following: whether the UE supports IDC assistance information for DC; whether the UE supports IDC assistance information for a SCG configured for the UE; or whether the UE supports IDC assistance information for IMD detection in DC.

It should be appreciated by persons skilled in the art that the sequence of the operations in exemplary procedure 700 may be changed and that some of the operations in exemplary procedure 700 may be eliminated or modified, without departing from the spirit and scope of the disclosure.

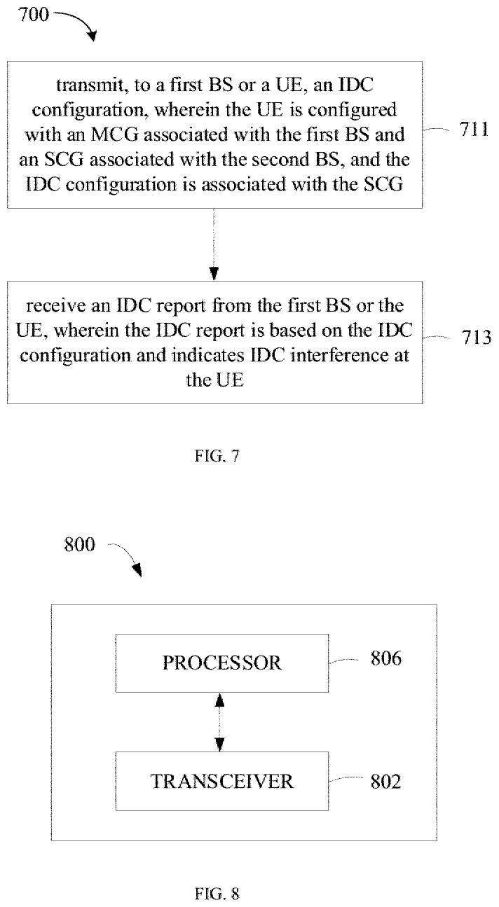

FIG. 8 illustrates a block diagram of an exemplary apparatus 800 according to some embodiments of the present disclosure.

As shown in FIG. 8, the apparatus 800 may include at least one processor 806 and at least one transceiver 802 coupled to the processor 806. The apparatus 800 may be a BS or a UE.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UEs described in FIGS. 1-7. In some embodiments of the present application, the apparatus 800 may be a BS. The transceiver 802 and the processor 806 may interact with each other so as to perform the operations with respect to the BSs described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UEs as described above. For example, the computer-executable instructions, when executed, cause the processor 806 interacting with transceiver 802 to perform the operations with respect to the UEs described in FIGS. 1-7.

In some embodiments of the present disclosure, the non-transitory computer-readable medium may have stored thereon computer-executable instructions to cause the processor 806 to implement the method with respect to the BSs as described above. For example, the computer-executable instructions, when executed, cause the processor 806 interacting with transceiver 802 to perform the operations with respect to the BSs described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive an in-device coexistence (IDC) configuration from a base station,
wherein the IDC configuration is associated with a first frequency to be detected by the UE, and the first frequency comprises at least one serving frequency, at least one non-serving frequency, or both;
detect IDC interference based on the configuration; and
transmit an IDC report to the base station BS in response to detecting the IDC interference.

2. The UE of claim 1, wherein the IDC configuration indicates at least one of:
at least one radio frequency channel number for the first frequency to be detected by the UE; or
a frequency offset relative to the at least one radio frequency channel number.

3. The UE of claim 2, wherein the IDC report indicates a second frequency affected by the IDC interference, and the second frequency is represented by:
the frequency offset and one of the at least one radio frequency channel number;
frequency offset, a weighting value of the frequency offset, and one of the at least one radio frequency channel number; or
indexes of radio frequency channel numbers associated with the second frequency among the at least one radio frequency channel number.

4. The UE of claim 1, wherein the IDC configuration indicates a minimum bandwidth for IDC reporting, or the minimum bandwidth and an incremental bandwidth.

5. The UE of claim 4, wherein the IDC report indicates a second frequency affected by the IDC interference, and a bandwidth of the second frequency is based on the minimum bandwidth or both the minimum bandwidth and the incremental bandwidth.

6. The UE of claim 5, wherein the IDC report comprises a weighting value of the minimum bandwidth or a weighting value of the incremental bandwidth.

7. The UE of claim 1, wherein the at least one processor is configured to cause the UE to receive at least one of the following from the base station:
a first indication enabling master node (MN) inter-modulation distortion (IMD) detection;
a second indication enabling secondary node (SN) IMD detection;
a third indication enabling IMD detection between an MN and an SN; or
a fourth indication enabling sidelink IMD detection.

8. The UE of claim 7, wherein the at least one processor is configured to cause the UE to perform at least one of the following:
in response to receiving the first indication, determining to report IMD related information for an MN of the UE;
in response to receiving the second indication, determining to report IMD related information for an SN of the UE;
in response to receiving the third indication, determining to report IMD related information between the MN and the SN of the UE; or
in response to receiving the fourth indication, determining to report IMD related information for a sidelink of the UE.

9. The UE of claim 1, wherein the IDC report comprises direction information of the IDC interference.

10. The UE of claim 9, wherein the direction information of the IDC interference indicates at least one of the following:
a victim of the IDC interference is a master cell group (MCG) configured for the UE;
a victim of the IDC interference is a secondary cell group (SCG) configured for the UE;
a victim of the IDC interference is a radio system based on a non-3GPP radio access technology (RAT);
a victim of the IDC interference is a sidelink of the UE;
a victim of the IDC interference comprises the MCG and SCG of the UE;
a victim of the IDC interference comprises the MCG of the UE and the sidelink of the UE;
a victim of the IDC interference comprises the MCG of the UE and the radio system based on a non-3GPP RAT;
a victim of the IDC interference comprises the SCG of the UE and the sidelink of the UE;
a victim of the IDC interference comprises the SCG of the UE and the radio system based on a non-3GPP RAT;
a victim of the IDC interference comprises the MCG and SCG of the UE and the sidelink of the UE; or
a victim of the IDC interference comprises the MCG and SCG of the UE and the radio system based on a non-3GPP RAT.

11. The UE of claim 1, wherein the at least one processor is configured to cause the UE to transmit, to the base station, IDC related capability, which indicates at least one of the following:
whether the UE supports IDC assistance information for dual connectivity (DC);
whether the UE supports IDC assistance information for a secondary cell group (SCG) configured for the UE; or
whether the UE supports IDC assistance information for inter-modulation distortion (IMD) detection in dual connectivity (DC).

12. A first base station, comprising:
at least one memory; and
at least one processor coupled with the at least one memory and configured to cause the first base station to:
transmit, to a user equipment (UE), an in-device coexistence (IDC) configuration, wherein the IDC configuration comprises a first IDC configuration associated with a master cell group (MCG) configured for the UE, a second IDC configuration associated with a secondary cell group (SCG) configured for the UE, or both, and the MCG and SCG are respectively associated with the first base station BS and second base station; and
an IDC report from the UE, wherein the IDC report is based on the IDC configuration and indicates IDC interference at the UE.

13. The first base station of claim 12, wherein at least one of the first IDC configuration or the second IDC configuration indicates at least one of:
at least one radio frequency channel number for a first frequency to be detected by the UE;
a bandwidth of the first frequency; or
a frequency offset relative to the at least one radio frequency channel number.

14. The first base station of claim 12, wherein at least one of the first IDC configuration or the second IDC configuration indicates at least one of:
a list of bandwidths for IDC reporting;
a minimum bandwidth for IDC reporting; or the minimum bandwidth and an incremental bandwidth.

15. A second base station, comprising:
at least one memory; and
at least one processor coupled with the at least one memory and configured to cause the second base station to:
transmit, to a first base station or a user equipment (UE), an in-device coexistence (IDC) configuration, wherein the UE is configured with a master cell group (MCG) associated with the first base station and a secondary cell group (SCG) associated with the second base station, and the IDC configuration is associated with the SCG; and
an IDC report from the first base station or the UE, wherein the IDC report is based on the IDC configuration and indicates IDC interference at the UE.

16. A method performed by a user equipment (UE), the method comprising:
receiving an in-device coexistence (IDC) configuration from a base station, wherein the IDC configuration is associated with a first frequency to be detected by the UE, and the first frequency comprises at least one serving frequency, at least one non-serving frequency, or both;
detecting IDC interference based on the configuration; and
transmitting an IDC report to the base station in response to detecting the IDC interference.

17. The first base station of claim 12, wherein the IDC report comprises at least one of the following:
a list of frequencies affected by the IDC interference;
a bandwidth(s) corresponding to the list of frequencies;
a cell group (CG) ID associated with the IDC interference; or
a victim type of the IDC interference.

18. The first base station of claim 12, wherein the at least one processor is configured to cause the first base station to perform at least one of the following:
transmitting a first message to the second base station in response to the first base station being unable to solve an IDC problem in the IDC report;
informing the second base station that an IDC problem in the IDC report is solved by the first base station; receiving, from the second base station, an indication that an IDC problem in the IDC report is solved by the second base station; or
receiving, from the second base station, a second message indicating that the second base station is unable to solve an IDC problem in the IDC report.

19. The first base station of claim 18, wherein the first message or the second message comprises at least one of the following:
a list of frequencies affected by the IDC problem;
a bandwidth(s) corresponding to the list of frequencies;
a cell group (CG) ID associated with the IDC problem;
a victim type of the IDC problem;
a suggestion for solving the IDC problem; or
a cause of the IDC problem.

20. The first base station of claim 18, wherein the at least one processor is configured to cause the first base station to perform at least one of the following:
receiving a first response to the first message, wherein the first response indicates whether the IDC problem is solved or not; or
transmitting a second response to the second message, wherein the second response indicates whether the IDC problem is solved or not.
